(19) United States
(12) Patent Application Publication
(10) Pub. No.: US 2026/0181498 A1
(43) Pub. Date: Jun. 25, 2026

(54) METHODS AND APPARATUSES TO SUPPORT AI/ML SERVICE CONTINUITY DURING CELL RESELECTION

(71) Applicant: InterDigital Patent Holdings, Inc., Wilmington, DE (US)

(72) Inventors: Dylan Watts, Montreal (CA); Oumer Teyeb, Montreal (CA); Patrick Tooher, Montreal (CA); Yugeswar Deenoo Narayanan Thangaraj, Chalfont, PA (US); Moon IL Lee, Melville, NY (US); Brian Martin, Farnham (GB); Virgil Comsa, Montreal (CA)

(73) Assignee: InterDigital Patent Holdings, Inc., Wilmington, DE (US)

(21) Appl. No.: 18/990,544

(22) Filed: Dec. 20, 2024

(51) Int. Cl. H04W 36/00; H04W 24/10

(52) U.S. Cl. CPC H04W 36/0085; H04W 24/10

(57) ABSTRACT

A wireless transmit/receive unit (WTRU) may receive a message from a first cell. The message may include a list of one or more cells, information associated with applicability of one or more artificial intelligence/machine learning (AI/ML) operations, and/or a bias to apply to measurements during cell reselection. The bias may be associated with prioritizing cells in which the WTRU is able to continue one or more AI/ML operations. The WTRU may apply the bias to measurements performed on the second cell based on one or more of the second cell being indicated by the network or the information associated with applicability of the one or more AI/ML operations of the second cell being the same as information associated with applicability of the one or more AI/ML operations of the first cell. The WTRU may reselect to the second cell based on the biased measurements.

### BACKGROUND

Integration of artificial intelligence/machine learning (AI/ML) may enhance air-interface performance (e.g., improved throughput, robustness, accuracy or reliability, etc.), reduce complexity, and/or reduce overhead. Selected features based on an assessment of their performance in comparison with traditional methods and the associated potential specification impact include AI/ML for beam management, positioning, and CSI prediction.

Consideration of multiple features enables a common AI/ML management framework, consisting of the following aspects: Signaling and protocol aspects of Life Cycle Management (LCM), Necessary signaling/mechanism(s) for LCM to facilitate model training, inference, performance monitoring, data collection for both wireless transmit/receive unit (WTRU) sided and network (NW) sided models, and Signaling mechanism of applicable functionalities/models.

The current AI/ML framework considers functionality-based LCM, wherein a functionality refers to an AI/ML feature enabled by configuration(s) and a network indicates activation/deactivation/fallback/switching of AI/ML functionality via signaling (e.g., radio resource control (RRC), media access control control element (MAC-CE), or downlink control information (DCI)). To support the configuration and (de) activation of a functionality, the WTRU reports whether a functionality is applicable based on WTRU and/or network-side additional conditions (e.g., WTRU speed, number of antennas etc.) and model availability at the WTRU. A WTRU may first be provided an AI/ML configuration and report whether the functionality is applicable based on the configuration, or the WTRU may report one or more applicable functionalities and subsequently receive an AI/ML configuration.

### SUMMARY

Methods and apparatuses may be described herein for cell (re) selection (de) prioritization based on artificial intelligence/machine learning (AI/ML) service continuity. Determination, methods, and duration to (de) prioritize cell(s) during cell (re) selection to support service continuity of AI/ML-related operation(s) and configuration(s) during cell (re) selection. The acquisition of assistance information and evaluation of criteria to perform cell (re) selection prioritization may be provided. Methods of cell (re) selection (e.g., bias, barring, ranking) may be provided. The duration to apply such prioritization (e.g., indefinitely, subject to a time condition) may be provided. Methods and apparatuses may be described herein for continuity of AI/ML operation upon cell (re) selection. Cell (re) selection, continuity, and/or subsequent notification to the network about AI/ML-related operation(s) and/or configuration(s) may be provided. The evaluation of criteria to continue AI/ML-related operation and/or configuration(s) within a second cell may be provided. WTRU action(s) in case one or more AI/ML related operation(s) and/or configuration(s) cannot be continued may be provided. Verification with the network that the AI/ML related operation(s) and/or configuration(s) may be continued may be provided.

A wireless transmit/receive unit (WTRU) may receive a message from a first cell. The message may include a list of one or more cells, information associated with applicability of one or more AI/ML operations, and/or a bias to apply to measurements during cell reselection. The bias may be associated with prioritizing cells in which the WTRU is able to continue the one or more AI/ML operations. The WTRU may perform measurements on a second cell of the one or more cells. The WTRU may apply the bias to the performed measurements based on one or more of the second cell being indicated by the network, the information associated with applicability of the one or more AI/ML operations of the second cell being the same as information associated with applicability of the one or more AI/ML operations of the first cell, or one or more network-side conditions of the second cell matching applicability criteria associated with the one or more AI/ML operations. The WTRU may reselect to the second cell based on the biased measurements.

The message from the first cell may be a radio resource control (RRC) release with suspend message. The bias may include an offset. The WTRU may send an indication to the second cell that indicates that the WTRU is performing the one or more AI/ML operations in the first cell. The WTRU may receive an acknowledgment (ACK) message from the network. The ACK message may indicate that the WTRU is able to continue performing the one or more AI/ML operations in the second cell. The WTRU may receive a negative acknowledgment (NACK) message from the network. The NACK message may indicate that the WTRU must discontinue performing the one or more AI/ML operations in the second cell. The one or more AI/ML operations may include one or more of data collection, model training, inference, or performance monitoring. The WTRU may initiate a random access channel (RACH) procedure when the one or more AI/ML operations are not supported by the second cell. The second cell may be selected based on the second cell supporting continuation of the one or more AI/ML operations. The WTRU may prioritize a first subset of the one or more cells based on the biased measurements. The WTRU may deprioritize a second subset of the one or more cells based on the biased measurements.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flow chart depicting an example method of service continuity of artificial intelligence/machine learning (AI/ML) operation(s) across cells during cell (re) selection.

### DETAILED DESCRIPTION

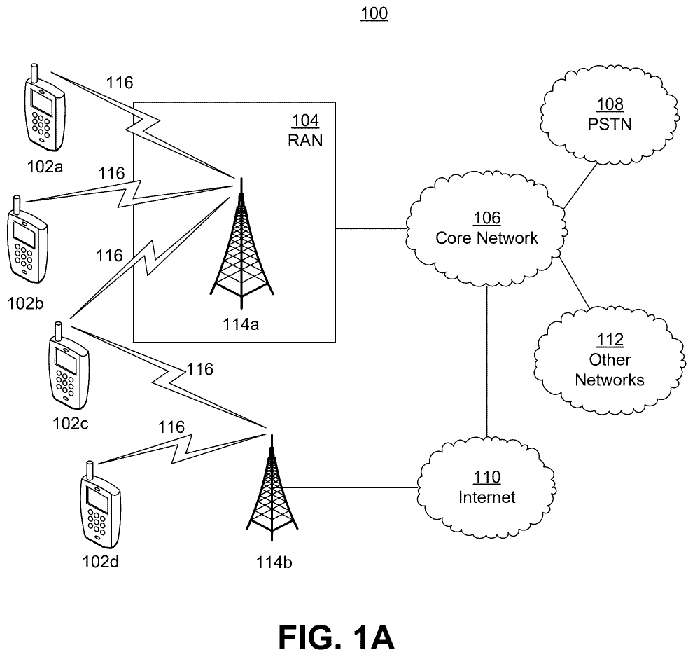

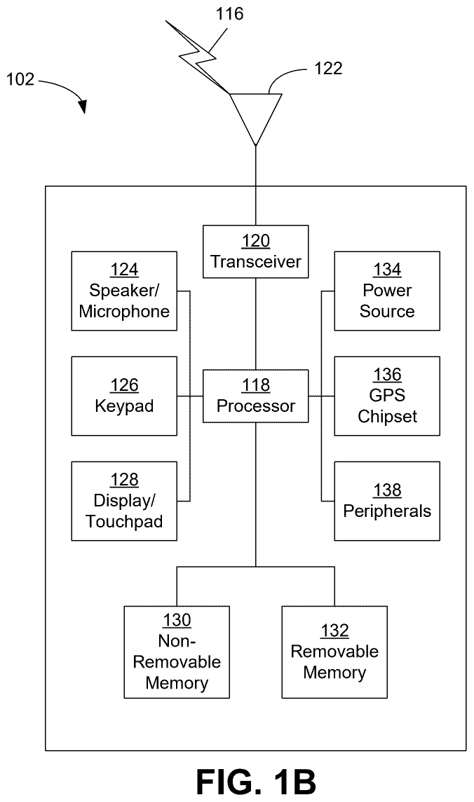

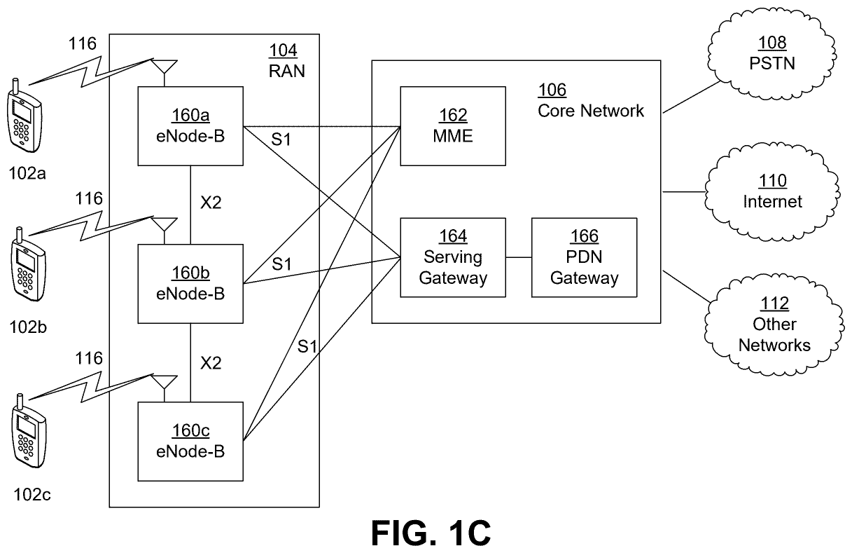

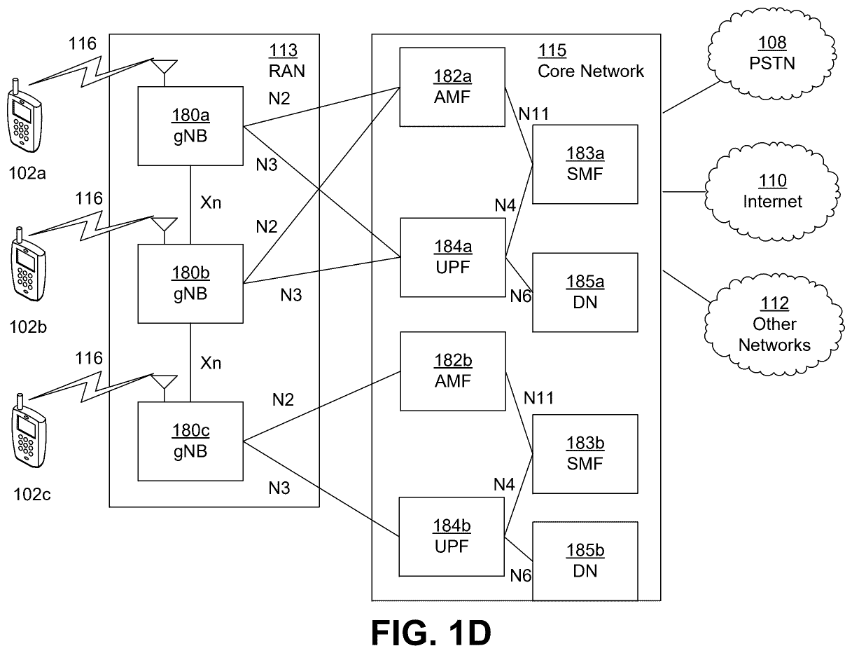

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Unlike RRC Connected where mobility between cells is network controlled, a WTRU in RRC IDLE/INACTIVE controls its own mobility via cell (re) selection. The WTRU makes measurements of attributes of the serving and neighbour cells to enable the reselection process. Cell reselection identifies the cell that the WTRU should camp on according to the following criteria: Intra-frequency reselection is based on ranking of cells; Inter-frequency reselection is based on absolute priorities where a WTRU tries to camp on the highest priority frequency available; A Neighbour Cell List (NCL) can be provided by the serving cell to handle specific cases for intra- and inter-frequency neighbouring cells; Exclude-lists can be provided to prevent the WTRU from reselecting to specific intra- and inter-frequency neighbouring cells; and Allow-lists can be provided to request the WTRU to reselect to only specific intra- and inter-frequency neighboring cells.

Service continuity of AI/ML operation may be enabled across cells during cell (re) selection. Some use cases (e.g., positioning) require AI/ML operation to span multiple cells. Service continuity of AI/ML operation may be an important consideration during mobility (e.g., to ensure AI/ML operation may continue in a target cell). Although service continuity of AI/ML operation may already be considered by the network in RRC Connected, mobility in RRC IDLE/INACTIVE is WTRU controlled, and may require additional enhancement to ensure service continuity of AI/ML operation (e.g., performance monitoring, data collection, etc.) during cell (re) selection.

LCM is currently defined for RRC_Connected mode and for the serving cell. There is no specified handling for how AI/ML functionality and/or LCM occurs in an IDLE/INACTIVE state.

Methods and apparatuses may be provided herein to enable service continuity of AI/ML operation (e.g., performance monitoring, data collection) across cells during cell (re) selection.

A WTRU may receive a message from a first cell that includes a list of one or more cell(s), their associated network-side additional conditions, and/or a bias to apply to measurement(s) during cell reselection. The WTRU may perform measurements on a second cell according to cell reselection criteria and/or configured bias(es). The WTRU may prioritize measurements from a second cell, for example, if the second cell shares the same network-side additional conditions as the first cell and/or if the second cell has network-side additional conditions matching the applicability criteria of one or more stored/deactivated AI/ML configuration(s). The WTRU may detect that the second cell satisfies condition(s) for cell (re) selection (e.g., including applied biases) and the WTRU may reselect to the second cell. The WTRU may continue AI/ML operation(s) on the second cell and may transmit an indication to the second cell that the WTRU is performing one or more AI/ML operations.

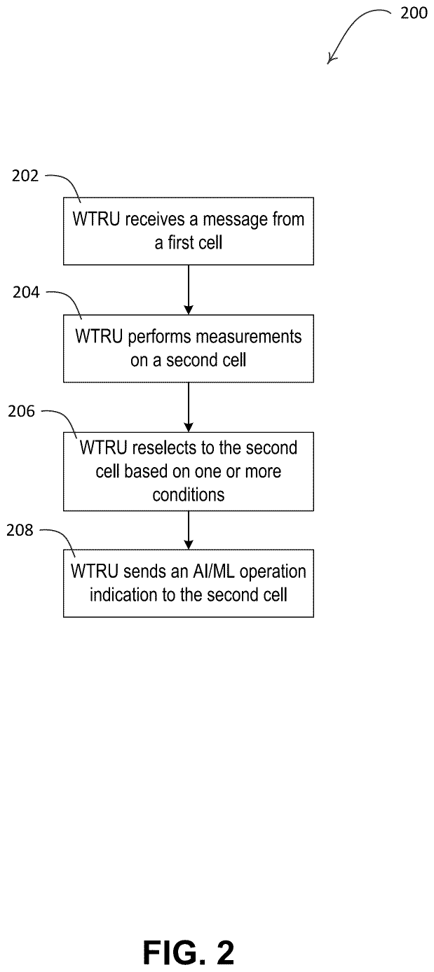

FIG. 2 depicts an example service continuity 200 of AI/ML operation across cells during cell (re) selection. At 202, a WTRU may receive a message (e.g., an RRC Release with suspend message) from a first cell including one or more of the following. The message from the first cell may include a list of one or more cell(s) (e.g., PCI, RNA, Tracking area etc.) and their associated network-side additional conditions (e.g., associated ID). The message from the first cell may include a bias (e.g., offset) to apply to measurement(s) during cell reselection (e.g., to (de) prioritize cell(s) where the WTRU may continue AI/ML operation).

At 204, the WTRU may perform one or more measurements on a second cell according to, a current AI/ML-related configuration(s), cell reselection criteria, and/or configured bias(es). The WTRU may prioritize measurements from a second cell (e.g., apply a positive bias/offset to measurements/frequencies associated with the second cell) if the second cell was explicitly indicated by the network (e.g., within a PCI list), shares the same network-side additional conditions as the first cell (and/or current camped cell), and/or has network-side additional conditions matching the applicability criteria of one or more stored/deactivated AI/ML configuration(s). The WTRU may deprioritize measurements from a second cell (e.g., apply a negative bias/offset to measurements/frequencies associated with the cell(s) with network side condition(s) different from the first cell (and/or current camped cell), with network-side additional conditions which do not match any stored/deactivated AI/ML configuration(s), and/or where the WTRU does not know the network-side additional conditions.

At 206, the WTRU may reselect to a second cell based on whether the second cell satisfies condition(s) for cell (re) selection (e.g., including supporting the continuation of AI/ML-related configuration(s) and/or considering applied biases). If AI/ML configuration(s) are applicable in the second cell, the WTRU may continue to perform AI/ML operation(s) (e.g., data collection, performance monitoring etc.) on the second cell (e.g., according to configurations received from the first cell). if AI/ML configuration(s) are not applicable in the second cell, the WTRU may release the AI/ML configuration and/or initiate RACH (e.g., to report an invalid cell, to receive a new AI/ML configuration, etc.).

At 208, the WTRU may send an indication to the second cell (e.g., via RACH or RRC Resume Request etc.) that the WTRU is performing AI/ML operation in the selected cell. The network may respond with an ACK (e.g., that indicates that the WTRU may continue AI/ML operation) or NACK (e.g., that indicates that the WTRU must discontinue AI/ML operation).

Support for LCM in IDLE/INACTIVE may enable AI/ML operation to be extended to RRC IDLE/INACTIVE. Support for LCM in IDLE/INACTIVE may be applied to future use cases/procedures such as cell (re) selection, measurement relaxation, small data transmission, paging optimization, RACH, Tracking area update etc. Continuing support for cell reselection may enable the WTRU to maintain AI/ML operation for a longer time and/or may enables seamless operation between cells.

Solutions described herein support service continuity of AI/ML operation across cells during cell (re) selection. The following terminology is used herein. The term ‘AI/ML operation’ may be defined as, for example, model training, inference, performance monitoring, and/or data collection.

A WTRU may receive a message from a first cell. The message may include a list of one or more cells, information associated with applicability of one or more AI/ML operations (e.g., an associated ID and/or one or more network-side conditions of the one or more cells), and/or a bias to apply to measurements during cell reselection. The bias may be associated with prioritizing cells in which the WTRU is able to continue one or more AI/ML operations. The WTRU may perform measurements on a second cell of the one or more cells. The WTRU may apply the bias to the performed measurements based on one or more of the second cell being indicated by the network, the information associated with applicability of the one or more AI/ML operations of the second cell being the same as information associated with applicability of the one or more AI/ML operations of the first cell, or one or more network-side conditions of the second cell matching applicability criteria associated with the one or more AI/ML operations. The WTRU may reselect to the second cell based on the biased measurements.

The message from the first cell may be a RRC release with suspend message. The bias may include an offset. The WTRU may send an indication to the second cell that indicates that the WTRU is performing the one or more AI/ML operations in the first cell. The WTRU may receive an acknowledgment (ACK) message from the network. The ACK message may indicate that the WTRU is able to continue performing the one or more AI/ML operations in the second cell. The WTRU may receive a negative acknowledgment (NACK) message from the network. The NACK message may indicate that the WTRU must discontinue performing the one or more AI/ML operations in the second cell. The one or more AI/ML operations may include one or more of data collection, model training, inference, or performance monitoring. The WTRU may initiate a random access channel (RACH) procedure when the one or more AI/ML operations are not supported by the second cell. The second cell may be selected based on the second cell supporting continuation of the one or more AI/ML operations. The WTRU may prioritize a first subset of the one or more cells based on the biased measurements. The WTRU may deprioritize a second subset of the one or more cells based on the biased measurements.

A WTRU may be provided with one or more configuration(s) for AI/ML service continuity during cell (re) selection. Examples may include configurations to support one or more of: AI/ML operation (e.g., model training, model transfer, inference, data collection, performance monitoring), cell (re) selection (de) prioritization (e.g., to support AI/ML service continuity), or service continuity of AI/ML-related configuration(s) and operation(s) to a second cell upon cell (re) selection.

Cell (re) selection enhancements to support AI/ML service continuity may be (e.g., only be) initiated if supported by both the WTRU and a network (NW). A WTRU may indicate capability for one or more aspects of cell (re) selection enhancements to support AI/ML service continuity e.g., prior to initiation of the procedure or reception of associated configurations. The NW may indicate support (e.g., per cell) for one or more aspects of cell (re) selection enhancements to support AI/ML service continuity. A WTRU may, for example, initiate (e.g., only initiate) a procedure and/or expect configuration with one or more cells which support the procedure. Solutions described herein support indication of WTRU capability, NW support, and/or the reception of one or more configurations to support cell (re) selection enhancements to support AI/ML service continuity.

In some solutions, a capability may be required for cell (re) selection enhancements to support AI/ML service continuity. The capability may be related to all aspects of cell (re) selection enhancements to support AI/ML service continuity or one or more aspects. Support for cell (re) selection enhancements to support AI/ML service continuity may be reported by the WTRU and/or indicated by the network (e.g., on a cell-specific basis).

WTRU capability reporting may be provided for cell (re) selection enhancements to support AI/ML service continuity. A WTRU may indicate capability and/or support for one or more aspects of cell (re) selection enhancements to support AI/ML service continuity. In examples, the WTRU may indicate a single capability to indicate support for all aspects of cell (re) selection enhancements to support AI/ML service continuity. In examples, the WTRU may report support for each aspect of cell (re) selection enhancements to support AI/ML service continuity. For example, the WTRU may indicate support for one or more of the following: a capability to continue one or more AI/ML-related operation(s) in a second cell, a capability to continue one or more AI/ML related use case(s) in a second cell, a capability to continue one or more AI/ML related configuration(s) in a second cell, a capability to prioritize cell(s) during cell (re) selection (e.g., to support AI/ML service continuity), or a capability to deprioritize cell(s) during cell (re) selection (e.g., to support AI/ML service continuity). An individual capability may be applied for each method of prioritization, including e.g., biasing, ranking, and/or cell barring. An individual capability may be applied for each method of de-prioritization, including e.g., biasing, ranking, and/or cell barring.

The WTRU may report the capability of one or more of the above aspects of cell (re) selection enhancements to support AI/ML service continuity, for example, via the WTRU capability transfer procedure. Additionally or alternatively, the WTRU may indicate capability and/or support via one or more of the following methods: random access (e.g., or use of one or more dedicated resources, use of random access preamble partitioning e.g., a set of reserved preambles or random access occasions, RNTIs etc.), upon RRC connection establishment/resumption (e.g., Msg3 or Msg5), upon request from the network (e.g., upon reception of the capability enquiry message), or WTRU assistance information.

In examples, capability to support/perform/execute/initiate one or more aspects of cell (re) selection enhancements to support AI/ML service continuity may be reliant/linked to one or more other configurations. For example, the network may assume that a WTRU is capable of one or more aspects of cell (re) selection enhancements to support AI/ML service continuity based on, for example, the activation, state, and/or configuration one or more of the following: a configuration of an AI/ML model and/or functionality, activation of an AI/ML model and/or functionality, or availability of an AI/ML model and/or functionality.

In examples, the capability and/or support for initiation of one or more aspects of cell (re) selection enhancements to support AI/ML service continuity may be reliant on one or more characteristics of the WTRU. For example, one or more of the following: performance of an AI/ML model and/or functionality of an AI/ML model, WTRU speed, remaining WTRU power, WTRU processing ability, WTRU location (e.g., within a certain set of cells, using one of a set of specific beams, GPS location, etc.), or when a particular type of service is in use (e.g., related to one or more specific network slices or QCIs).

If a WTRU is configured for cell (re) selection enhancements to support AI/ML service continuity and an associated configuration is not present and/or active and/or the WTRU characteristics are not suitable, the WTRU may assume that the procedure is temporarily disabled (e.g., the WTRU may not initiate the procedure) or inactive. The WTRU may indicate (e.g., subject to configuration) to the network cell (re) selection enhancements to support AI/ML service continuity is temporarily inactive e.g., via a MAC CE, UCI or RRC signalling. In examples, the WTRU may report (e.g., also report) the reason for why the procedure is inactive (e.g., a joint configuration is disabled, or the WTRU characteristics are not suitable).

In examples, the network may indicate support for cell (re) selection enhancements to support AI/ML service continuity. Support cell (re) selection enhancements to support AI/ML service continuity may be, for example, per cell, per PLMN, per frequency, per tracking area (TA) or RAN notification area (RNA). The indication may be, for example a flag and/or bit in system information which indicates support cell (re) selection enhancements to support AI/ML service continuity. In examples, the NW may indicate support for an aspect of the procedure (e.g., that the cell supports data collection but not model transfer etc.). In examples, the network may indicate (e.g., within system information and/or via RRC configuration) a list of one or more cell(s) which support cell (re) selection enhancements to support AI/ML service continuity.

The WTRU may initiate (e.g., only initiate) cell (re) selection enhancements to support AI/ML service continuity or one or more aspects of cell (re) selection enhancements to support AI/ML service continuity subject to the network supporting the procedure. For example, the WTRU may resume (e.g., only resume) cell (re) selection enhancements to support AI/ML service continuity if the cell has indicated support for cell (re) selection enhancements to support AI/ML service continuity.

In examples, the WTRU may receive configuration(s) (e.g., configuration information) to support one or more AI/ML operation(s). Examples include configurations for model training, inference, performance monitoring, data collection, and/or applicability reporting.

The WTRU may receive configuration(s) (e.g., configuration information) for AI/ML model training. Examples of configuration(s) for model training may include, for example, one or more of: criteria for updating a model, criteria for determining when a model is done training, criteria for downloading a new model, criteria for re-training a model, or one or more configurations to train a model (e.g., duration of training, number of iterations etc.).

The WTRU may receive configuration(s) (e.g., configuration information) for AI/ML inference. Examples of configuration(s) for inference may include, for example, one or more of: model(s) in which to perform inference, one or more information characteristics needed for input, or one or more NW-side additional conditions and/or associated ID(s) which the model has been trained on.

The WTRU may receive configuration(s) (e.g., configuration information) for AI/ML performance monitoring. Examples of configuration(s) for performance monitoring may include, for example, one or more of: when to perform performance monitoring (e.g., periodicity, duration etc.), criteria for performance monitoring (e.g., thresholds), or criteria to report performance monitoring results (e.g., performance has dropped below a threshold).

The WTRU may receive configuration(s) (e.g., configuration information) for AI/ML data collection. Examples of configuration(s) for data collection may include, for example, one or more of: one or more measurement configurations, one or more associated IDs, one or more NW-side additional conditions, one or more limits on the amount of data collected, one or more types of data and/or events to collect, one or more triggers to report collected data, or one or more formats to report collected data.

The WTRU may receive configuration(s) (e.g., configuration information) for AI/ML applicability reporting. Examples of configuration(s) for applicability reporting may include, for example, one or more of: whether to proactively or reactively report the applicability, whether the WTRU can report non-applicability, whether the WTRU can transmit an update during the connected regarding the applicability of a model, or one or more triggering conditions to report applicability (e.g., a functionality becomes non-applicable).

In examples, the WTRU may receive configuration(s) (e.g., configuration information) to support cell (re) selection (de) prioritization. Examples configurations include those needed to support the determination, prioritization, and duration in which to prioritize a cell to support AI/ML service continuity during cell (re) selection.

In examples, a WTRU may receive configuration(s) (e.g., configuration information) for evaluating whether the apply cell (re) selection prioritization. Examples of configuration(s) may include, for example, one or more of: an indication (e.g., a flag and/or bit) to enable/disable cell (re) selection prioritization or whether the WTRU may request assistance information for cell (re) selection prioritization.

The WTRU may receive configuration(s) (e.g., configuration information) for prioritizing one or more neighbouring cell(s) during cell (re) selection. Examples of configuration(s) may include, for example, one or more of: a bias and/or offset (e.g., to apply to neighbor cell measurements), whether the WTRU can bar cell(s) not applicable for continuation of an AI/ML related configuration, whether the WTRU can not perform measurements on cell(s) not applicable for continuation of an AI/ML configuration, or whether the WTRU may adjust the frequency ranking.

The WTRU may receive configuration(s) (e.g., configuration information) to determine the duration to apply cell (re) selection prioritization. Examples of configuration(s) may include, for example, one or more of: an indication (e.g., a flag and/or bit) to apply cell (re) selection prioritization indefinitely, a duration to apply cell (re) selection prioritization, or whether the WTRU can apply the prioritization periodically (and associated periodicity, duration etc.).

The WTRU may receive configuration(s) (e.g., configuration information) to support AI/ML service continuity upon cell (re) selection. Examples include configurations for the continuity of AI/ML operation within a second cell and/or notification that a WTRU is applying AI/ML operation in a second cell.

In examples, a WTRU may receive configuration(s) (e.g., configuration information) to support the continuity of AI/ML operation in a second cell. Examples of configuration(s) may include, for example, one or more of: an indication (e.g., a flag or bit) that the WTRU may continue AI/ML related operation and/or configuration(s) within the cell; an indication (e.g., a flag or bit) that the WTRU may continue a specific AI/ML related operation; or an indication (e.g., a flag or bit) that the WTRU may continue AI/ML related operation related to a specific use case (e.g., positioning, beam management, CSI prediction/compression etc.).

A WTRU may receive configuration(s) (e.g., configuration information) for notifying the network that a WTRU is applying AI/ML operation in a second cell. Examples of configuration(s) may include, for example, one or more of: an indication (e.g., a flag or bit) that the WTRU must notify the network when it is performing AI/ML-related operation(s) within a second cell; an indication (e.g., a flag or bit) that the WTRU does not need to notify the network when it is performing AI/ML-related operation(s) within a second cell; or one or more configurations related to accessing the network to inform continued AI/ML operation (e.g., RACH preambles, RACH resources, dedicated RNTIs).

One or more methods to (re) acquire, adapt, and/or release configurations for cell (re) selection enhancements to support AI/ML service continuity may be necessary to ensure a WTRU may continue to maintain related AI/ML configuration(s) and/or AI/ML operation upon cell (re) selection.

The WTRU may be provided with configurations (e.g., configuration information) for cell (re) selection enhancements to support AI/ML service continuity upon establishment/resumption of an RRC connection (e.g., within the RRC Setup/Resume message) or upon handover to another cell (e.g., within a HO command/RRC reconfiguration message with a reconfiguration with sync) or at any time during an active RRC connection (E.g., RRC reconfiguration message without reconfiguration with sync). In examples, configurations (e.g., configuration information) for cell (re) selection enhancements to support AI/ML service continuity may be indicated/configured/provided via one or more of the following signaling methods: SIB (e.g., a new SI block, or within another existing SIB), NAS, MAC CE, DCI, RACH (e.g., MSG2, MSG4, MSGB), RRC, and/or PDCCH/PUSCH.

In examples, the WTRU may receive different information and/or components of a configuration for cell (re) selection enhancements to support AI/ML service continuity via different signaling methods. For example, the WTRU may receive some dedicated configuration aspects via RRC signalling (e.g., which configuration(s) and/or AI/ML operations to may be continued in a second cell, dedicated RNTIs to access the cell to receive updated configurations etc.), and some other configurations or information via system information (e.g., and indication that a specific AI/ML-related operation is supported in the cell). If a WTRU is provided with a dedicated configuration/indication related to cell (re) selection enhancements to support AI/ML service continuity, the WTRU may override other common configuration information (e.g., received via broadcast signalling) or may combine the dedicated configuration with one or more pieces of common configuration information. In another example, the WTRU may use the most recently received information in the configuration regardless of the signalling method.

The WTRU may receive one or more alternative configurations using one signalling method (e.g., via system information or dedicated RRC signalling). Using another type of signalling (e.g., via dedicated RRC signalling or MAC CE) the network may select or indication which of the one or more alternative configurations to apply.

The WTRU may receive a configuration (e.g., configuration information) based on a NW decision (e.g., upon release to RRC IDLE or RRC INACTIVE) for example, if the WTRU indicates it is capable of cell (re) selection enhancements to support AI/ML service continuity. In examples, the WTRU may request to be configured cell (re) selection enhancements to support AI/ML service continuity.

The WTRU may request configuration(s) (e.g., configuration information) for cell (re) selection enhancements to support AI/ML service continuity, update existing configuration(s) cell (re) selection enhancements to support AI/ML service continuity, and/or apply different configuration(s) for cell (re) selection enhancements to support AI/ML service continuity

The WTRU may release related configurations for cell (re) selection enhancements to support AI/ML service continuity (e.g., all or one or more parts of a configuration), for example, upon one or more of the following circumstances: the current serving cell does not support cell (re) selection enhancements to support AI/ML service continuity or the WTRU does not have an active, available, configured, or supported AI/ML functionality/model to continue in the second cell.

A WTRU may adapt (e.g., change) one or more aspects of configuration(s) for cell (re) selection enhancements to support AI/ML service continuity based on the WTRU characteristics. Examples of WTRU characteristics may include: WTRU speed and/or position, WTRU power and/or battery level, or WTRU processing capability and/or load. Upon detection of a change in one or more WTRU characteristics, the WTRU may modify one or more aspects of the current configuration and/or apply a new configuration. How the WTRU detects which aspects of the configuration to change may be based on conditions associated with the configuration and/or aspect(s) of the configuration. For example, the WTRU may be provided with one or more threshold(s), wherein if a threshold is exceeded (e.g., or if a value has fallen below a threshold) the WTRU will apply an alternative configuration and/or value for the same configuration.

A WTRU may (de) prioritize one or mode neighbouring cell(s) during cell (re) selection, for example, to increase the probability that a WTRU may (re) select to a cell where it may continue AI/ML-related operation(s) and/or configuration(s). Such solutions support the service continuity of AI/ML-related operation(s) during the cell (re) selection procedure.

Solutions described herein support the (de) prioritization of one or more cell(s) for cell (re) selection based on the continuation of AI/ML operation(s) and/or configuration(s), including methods to acquire relevant information to perform cell (re) selection prioritization, when and how to perform cell (re) selection prioritization, and the duration in which to perform cell (re) selection prioritization.

The WTRU may determine whether to (de) prioritize a cell or set of cell(s) during cell (re) selection. The determination whether to (de) prioritize a cell or set of cells during cell (re) selection, may consider, for example, assistance information acquired from one or more cell(s) and/or the evaluation of one or more corresponding criteria.

The WTRU may acquire additional information and/or configuration(s) to perform cell (re) selection prioritization. The assistance information may be specific to a neighbouring cell, or may apply to several (e.g., more than one) neighbouring cell(s). In examples, the WTRU may receive a list of cell(s) (e.g., a list of cell IDs and/or PCIs) with each cell associated with one or more pieces of assistance information. The WTRU may receive, for example, one or more of the following assistance information for one or more neighbouring cell(s) to support cell (re) selection: whether AI/ML operation is supported in the cell, one or more network-side additional condition(s) for the cell, an associated ID for the cell, a set of AI/ML operation(s) (e.g., model training, inference, performance monitoring, data collection) supported by the second cell, a set of AI/ML use case(s) (e.g., positioning, beam management, CSI prediction/compression) supported by the second cell, whether the cell supports the current set of AI/ML-related configuration(s), or whether the cell supports AI/ML operation in IDLE/INACTIVE.

The assistance information may be provided via RRC signaling (e.g., within the RRC Release or Release with suspend message) for example, from the serving cell upon the WTRU being released to IDLE/INACTIVE. In examples, the WTRU may receive assistance information directly from one or more cell(s) (e.g., via system information of a second cell).

In examples, the WTRU may request assistance information from a second cell (e.g., if the WTRU does not have the assistance information currently stored). The WTRU may transmit a RACH message using a dedicated preamble/RACH occasions/RACH resources to indicate that the WTRU would like AI/ML assistance information. Additionally or alternatively, the WTRU may have a dedicated resume cause to acquire assistance information for AI/ML service continuity. The WTRU may transmit two set RACH and indicate (e.g., with MSGA PUSCH resources) that it would like to receive cell (re) selection prioritization.

The WTRU may use the assistance information indefinitely. The WTRU may use the assistance information subject to a time period (e.g., for a specific time and/or duration). The WTRU may start the duration upon reception of the assistance information and start a timer. While the timer is running, the WTRU may continue to use the assistance information for cell (re) selection. The WTRU may use the assistance information as long as the WTRU is camped on a cell included within the list of cell IDs (e.g., provided upon release from RRC Connected). The WTRU may continue to use the assistance information as long as the WTRU remains within a PLMN, Tracking area, RAN notification area, or list of cell(s).

In examples, the WTRU may (de) prioritize a cell for (re) selection (e.g., to support continuity of AI/ML operation in a second camped cell). The WTRU may prioritize a neighbouring cell (e.g., as described herein), for example, upon satisfaction of one or more of the following condition(s): the neighbouring cell was explicitly indicated by the network (e.g., within a PCI list), the neighbouring cell shares the same network-side additional conditions as the first cell (and/or current camped cell), the neighbouring cell has network-side additional conditions matching the applicability criteria of one or more stored/deactivated AI/ML configuration(s), or the WTRU may continue AI/ML operation(s) on the neighbouring cell (e.g., while in IDLE/INACTIVE).

The WTRU may deprioritize a neighbouring cell (e.g., as described herein), for example, upon satisfaction of one or more of the following condition(s): with network side condition(s) different from the first cell (and/or current camped cell), with network-side additional conditions which do not match any stored/deactivated AI/ML configuration(s), where the WTRU does not know the network-side additional conditions, the cell does not support AI/ML operation (e.g., within RRC IDLE/INACTIVE), or the WTRU may need additional configuration(s) to continue AI/ML operation.

The WTRU may use the provided assistance information to determine which of the above condition(s) (if any) are satisfied. If the WTRU does not have assistance information available and/or the WTRU was unable to request assistance information form the cell to determine whether the WTRU should (de) prioritize the cell, the WTRU may either deprioritize the cell, not consider it for cell (re) selection (e.g., bar the cell), or treat the cell as “neutral” (e.g., the WTRU does not prioritize nor deprioritize the cell).

Upon configuration, indication, or satisfaction of one or more criteria described herein associated with (de) prioritization of a cell or set of cells during cell (re) selection, the WTRU may perform cell reselection prioritization. The WTRU may determine which cell (re) selection prioritization method is selected, for example, which AI/ML operation(s) are currently active, received configuration, and/or which criteria(s) have been satisfied.

A WTRU may receive and/or be configured with one or more cell (re) selection bias(es) to apply to cell ranking measurements e.g., to prioritize a second cell in which the WTRU may continue AI/ML related operation(s) and/or configuration(s). A bias may be positive or negative, and may have one or more associated criteria to apply the bias, for example: a PLMN ID, wherein the WTRU will apply the bias to all cells/frequencies associated with that PLMN; a cell ID, wherein the WTRU will apply the bias to that cell; a frequency or range of frequencies, wherein the WTRU will apply the bias to all frequencies within the indicated range, a threshold, or a state. For example, if a prioritization criteria meets, exceeds, or falls below a configured threshold, the WTRU may apply a bias. For example, if a prioritization criteria or configuration is equivalent to the indicated state, the WTRU may apply a bias.

If a WTRU is configured with multiple biases, a WTRU may apply one or more (e.g., all) biases which the associated criteria has been satisfied. For example, the WTRU may select the largest absolute value among the multiple biases applied to a PLMN, or frequency range and apply that (e.g., only that) bias. Additionally or alternatively, the WTRU may select the largest positive and negative bias apply the sum of both biases.

A WTRU may prioritize a cell independently of measurements. For example, the WTRU may evaluate (e.g., only evaluate) candidate cells which support one or more AI/ML operation(s) and/or where the WTRU may continue with the current AIML configuration(s). Additionally or alternatively, the WTRU may evaluate (e.g., only evaluate) candidate cells from a second cell which does not support AI/ML-related operation(s) after one or more (e.g., only after all) frequencies/candidate cells have been evaluated for cell(s) which do support AI/ML-related operations.

For example, a WTRU may prioritize a cell by down selecting and/or eliminating candidate cells for cell (re) selection which do not support the continuation of AI/ML-related operation(s) and/or configuration(s). The WTRU may down select and/or eliminate candidate cells and/or frequencies via one or more of the following methods: barring cells which do not support an AI/ML operation(s), barring/not performing measurements on frequencies associated with cell(s) which do not support AI/ML operation(s), or barring PLMNs associated cell(s) which do not support AI/ML operation(s).

A WTRU may adjust cell ranking based on support for AI/ML-related operation. For example, a WTRU may group one or more (e.g., all) cell(s) which support AI/ML-related operation and/or the current AI/ML configuration(s), as well as one or more (e.g., all) cell(s) which do not support AI/ML-related operation and/or the current AI/ML configuration(s). The WTRU may then rank the one or more (e.g., all) cell(s) within each group (e.g., based on the signal quality as per legacy ranking). The WTRU may then rank the group of cell(s) which support AI/ML-related operation first (e.g., regardless of the quality of measurements) followed by the group of cell(s) which do not support AI/ML related operation.

The WTRU may apply cell (re) selection prioritization semi-statically (e.g., based on configuration). The WTRU may apply cell (re) selection prioritization based on satisfaction of a criteria (e.g., as described herein).

In examples, the WTRU may apply cell (re) selection prioritization temporarily (e.g., subject to timing conditions), for example, while a timer is running. For example, upon application of cell (re) selection prioritization the WTRU may start a timer upon expiry of which the WTRU may stop cell (re) selection prioritization. The WTRU may apply cell (re) selection prioritization temporarily (e.g., subject to timing conditions), for example, subject to a counter. For example, the WTRU may apply cell (re) selection prioritization for the next X resources (e.g., frames, subframes, symbols). The WTRU may apply cell (re) selection prioritization temporarily (e.g., subject to timing conditions), for example, until an indicated time. For example, until 10:00:35 UTC. The WTRU may apply cell (re) selection prioritization temporarily (e.g., subject to timing conditions), for example, for a time period. For example, between 10:00:35 UTC and 10:00:40 UTC. The WTRU may apply cell (re) selection prioritization temporarily (e.g., subject to timing conditions), for example, when the WTRU is configured with time and/or location based conditions, for example in the case of using NTN. For example, when the WTRU location is within a threshold distance from a reference location and/or when the absolute time measured at the WTRU is within a time window (e.g., between T1 and T2).

In examples, the WTRU may, upon release to RRC IDLE/INACTIVE mode (e.g., reception of an RRCRelease or RRCReleasewith Suspend message) start a timer. The WTRU may apply cell (re) selection prioritization for (e.g., only for) the indicated or configured duration. The WTRU may start a timer and/or counter upon starting cell (re) selection prioritization. The WTRU may start a timer and/or counter after the last time it has camped on a cell where the WTRU has applied AI/ML-related operation(s). An offset may be optionally applied to the start of the timer and/or counter.

Upon expiry of the timing condition(s), the WTRU may perform one or more of the following actions: stop one or more AI/ML-related operation(s); release one or more AI/ML-related configuration(s); stop applying cell (re) selection prioritization; revert to a default or alternate cell (re) selection prioritization configuration/method; discard associated cell (re) selection prioritization configuration(s); perform cell (re) selection; or perform random access (e.g., transmit a preamble).

A WTRU may apply cell (re) selection prioritization periodically. For example, the WTRU may be provided with a series of times in which to apply cell (re) selection prioritization.

In examples, the WTRU may be provided/configured with a time (e.g., UTC 10:00:32) and an offset (e.g., 5 minutes or X frames). The WTRU-side will apply cell (re) selection prioritization at each original time+X*Offset, wherein X may be a configurable number (e.g., integer).

Additionally or alternatively, the WTRU may be provided with multiple timers, for example, such as a cycle duration timer and an on duration timer. The WTRU may apply cell (re) selection prioritization while the on duration timer is running. Upon expiry of the on duration timer, the WTRU may wait until the cycle duration timer restarts before starting the on duration timer again, wherein the WTRU will re-apply cell (re) selection prioritization.

A WTRU may continue AI/ML-related operation(s) and/or configuration(s) within a second cell (e.g., upon cell (re) selection to a cell specifically prioritized to continue AI/ML operation as described herein). Continuity of AI/ML operation may depend on, for example, specific criteria and/or network acceptance, which may be further evaluated by the WTRU upon reselection to the second cell. Such solutions ensure service continuity of AI/ML operation(s) upon cell reselection and coordination between the WTRU and network.

Solutions described herein support the continuity of AI/ML operation in a second cell (e.g., upon cell (re) selection), including the evaluation of criteria to continue AI/ML-related operation and/or configuration(s) within a second cell, WTRU action(s) in case one or more AI/ML related operation(s) and/or configuration(s) cannot be continues, and/or verification with the network that the AI/ML related operation(s) and/or configuration(s) may be continued.

The WTRU may evaluate whether the WTRU may continue AI/ML operation within a second cell upon completion of cell (re) selection. The evaluation may consider, for example, which AI/ML operation(s) the WTRU wishes to perform, the specific use case, and/or the configuration the WTRU is using to perform the AI/ML operation.

The WTRU may continue AI/ML operation within a second cell, for example, after (re) selecting to that cell. The WTRU may continue (e.g., only continue) to apply AI/ML operation within a second cell subject to satisfaction of one or more conditions/criteria. Examples of the conditions/criteria may include one or more of the following: the cell supports AI/ML operation, the cell supports AI/ML operation in RRC IDLE/INACTIVE, the cell supports a specific use case, or the cell supports AI/ML operation with a specific configuration (e.g., the current WTRU configuration).

The second cell may support (e.g., only support) a specific subset of AI/ML operation(s) or AI/ML use cases. For example, the second cell may support data collection for positioning and beam management, but may not support inference or any CSI-related operation. Upon cell (re) selection, the WTRU may apply (e.g., only apply) the AI/ML operation and/or AI/ML use case(s) supported by the second cell.

When the WTRU performs a cell reselection from the cell on which the configuration was received to a new cell, the WTRU may obtain updated configuration information from the system information of the new cell. For example, the new cell may indicate applicability for some, but not necessarily all, of the of AI/ML operation(s) or AI/ML use cases which were configured by the original cell.

The WTRU may require a revised and/or updated configuration from the second cell (e.g., examples of possible configurations include an updated to one or more of those described herein). If the current AI/ML configuration is required to be updated, the WTRU may request an revised configuration from the cell via e.g., triggering RACH etc.).

The WTRU may fail to continue AI/ML operation within a second cell. The WTRU may fail to continue AI/ML operation within a second cell, for example, due to one or more of the following: there is no suitable cell that supports AI/ML operation, there is no suitable cell that supports the required AI/ML use case, there is no suitable cell with network side additional conditions applicable for the AI/ML functionality/model, or the current AI/ML-related configuration(s) are not suitable for operation on the second cell.

The WTRU may perform a different action depending on the cause of the failure. Upon failure to continue AI/ML operation, the WTRU may perform one of more of the following actions: suspend and/or terminate AI/ML operation(s), release configuration(s) (e.g., related to suspended and/or terminated AI/ML operation(s), re-attempt cell (re) selection, or perform RACH.

When the WTRU cannot find any suitable cell for cell (re) selection which can support any AI/ML operation, the WTRU may release AI/ML related configuration(s). When the second cell support(s) AI/ML operation, but the WTRU is missing a related configuration (e.g., or the current configuration is not suitable), the WTRU may initiate RACH.

When the WTRU maintains AI/ML-related configuration(s) and temporarily suspends the AI/ML operation, the WTRU may perform cell (re) selection, for example, until a suitable cell has been found to perform cell (re) selection. The WTRU may perform this cell (re) selection periodically and/or subject to a backoff timer.

The WTRU may notify the second cell that it is currently performing AI/ML operation, for example, upon (re) selection to a second cell. The WTRU may indicate to the network, for example, via initiation of a connection (e.g., via RACH). The WTRU may transmit an AI/ML operation notification within a resume request or a dedicated resume cause.

The WTRU may notify the network (e.g., via a flag or bit) that the WTRU is performing AI/ML operation within the cell. The WTRU may provide additional assistance information within the indication that the WTRU is performing AI/ML operation within the cell. The additional assistance information may include information regarding the type and/or characteristics of AI/ML operation. The WTRU may indicate, for example, one or more of the following to the network: that the WTRU is performing AI/ML operation within the cell, the current configuration(s) the WTRU is using to perform AI/ML operation.

The network may respond to the WTRU (e.g., via RACH, RRC, MAC CE, NAS, PDCCH, and/or PDSCH). For example, the network may respond with an acknowledgement. The acknowledgement may include, for example, one or more of the following: an indication that the WTRU may continue AI/ML operation within the cell, an indication that the WTRU may continue with a specific AI/ML operation within the cell, or an indication that the WTRU may continue with the current configuration(s).

The network may respond with a rejection. The rejection may include, for example, one or more of the following: an indication that the WTRU cannot continue AI/ML operation within the cell, an indication that the WTRU cannot continue a specific AI/ML operation with the cell (e.g., data collection, inference, model training etc.), an indication that the WTRU cannot continue with the current configuration(s), an indication that the WTRU should release current AI/ML related configuration(s), or an indication that the WTRU is re-directed from the cell (e.g., the WTRU is ordered to bar the cell).

The WTRU may perform a different action depending on the network response. The WTRU may terminate and/or suspend AI/ML operation within the cell, for example, if the WTRU cannot continue AI/ML operation (e.g., and/or a specific AI/ML operation).

The WTRU may initiate a connection with the current cell and receive an updated configuration, for example, If the WTRU cannot continue with the current configuration. In other solutions, the network may also directly provide the delta configuration information within the notification.

the WTRU may suspend and/or terminate the AI/ML operation(s) indicated by the network and/or release associated configuration(s), for example, if the WTRU can only continue specific AI/ML operations.

A WTRU may receive a message (e.g., the RRC Release with suspend message) from a first cell. The message may include one or more of the following. The message may include a list of one or more cell(s) (e.g., PCI, RNA, Tracking area etc.) and/or their associated network-side additional conditions (e.g., associated ID). The message may include a bias (e.g., offset) to apply to measurement(s) during cell reselection (e.g., to (de) prioritize cell(s) where the WTRU may continue AI/ML operation).

The WTRU may perform one or more measurements on a second cell according to a current AI/ML-related configuration(s), cell reselection criteria, and/or configured bias(es). The WTRU may prioritize measurements from a second cell (e.g., apply a positive bias/offset to measurements/frequencies associated with the second cell) if the second cell was explicitly indicated by the network (e.g., within a PCI list), shares the same network-side additional conditions as the first cell (e.g., and/or current camped cell), and/or has network-side additional conditions matching the applicability criteria of one or more stored/deactivated AI/ML configuration(s). The WTRU may deprioritize measurements from a second cell (e.g., apply a negative bias/offset to measurements/frequencies associated with the cell(s)): with network side condition(s) different from the first cell (e.g., and/or current camped cell), with network-side additional conditions which do not match any stored/deactivated AI/ML configuration(s), and/or where the WTRU does not know the network-side additional conditions.

The WTRU may reselect to a second cell based on whether the second cell satisfies one or more conditions for cell (re) selection. The one or more conditions for cell (re) selection may include supporting the continuation of AI/ML-related configuration(s) and/or considering applied biases). The WTRU may continue to perform AI/ML operation(s) (e.g., data collection, performance monitoring etc.) on the second cell (e.g., according to configurations received from the first cell), for example, if the AI/ML configuration(s) are applicable in the second cell. The WTRU may release the AI/ML configuration and/or initiate RACH (e.g., to report an invalid cell, to receive a new AI/ML configuration, etc.).

The WTRU may transmit an indication to the second cell (e.g., via RACH or RRC Resume Request etc.) that the WTRU is performing an AI/ML operation in the selected cell. The network may respond with an ACK (e.g., indicating that the WTRU may continue AI/ML operation) or a NACK (e.g., indicating that the WTRU must discontinue AI/ML operation).

1. A wireless transmit/receive unit (WTRU) comprising:
a memory and a processor, wherein the processor is configured to:
receive a message from a first cell, the message comprising a list of one or more cells, information associated with applicability of one or more artificial intelligence/machine learning (AI/ML) operations, and a bias to apply to measurements during cell reselection, wherein the bias is associated with prioritizing cells in which the WTRU is able to continue the one or more AI/ML operations;
perform measurements on a second cell of the one or more cells;
apply the bias to the performed measurements based on one or more of the second cell being indicated by the network, the information associated with applicability of the one or more AI/ML operations of the second cell being the same as information associated with applicability of the one or more AI/ML operations of the first cell, or one or more network-side conditions of the second cell matching applicability criteria associated with the one or more AI/ML operations; and
reselect to the second cell based on the biased measurements.

2. The WTRU of claim 1, wherein the message from the first cell is a radio resource control (RRC) release with suspend message.

3. The WTRU of claim 1, wherein the bias comprises an offset.

4. The WTRU of claim 1, wherein the processor is further configured to send an indication to the second cell that indicates that the WTRU is performing the one or more AI/ML operations in the first cell.

5. The WTRU of claim 4, wherein the processor is further configured to receive an acknowledgment (ACK) message from the network, the ACK message indicating that the WTRU is able to continue performing the one or more AI/ML operations in the second cell.

6. The WTRU of claim 4, wherein the processor is further configured to receive a negative acknowledgment (NACK) message from the network, the NACK message indicating that the WTRU must discontinue performing the one or more AI/ML operations in the second cell.

7. The WTRU of claim 1, wherein the one or more AI/ML operations comprise one or more of data collection, model training, inference, or performance monitoring.

8. The WTRU of claim 1, wherein the processor is further configured to initiate a random access channel (RACH) procedure when the one or more AI/ML operations are not supported by the second cell.

9. The WTRU of claim 1, wherein the second cell is selected based on the second cell supporting continuation of the one or more AI/ML operations.

10. The WTRU of claim 1, wherein the processor is further configured to:
prioritize a first subset of the one or more cells based on the biased measurements; and
deprioritize a second subset of the one or more cells based on the biased measurements.

11. A method performed by a wireless transmit/receive unit (WTRU), the method comprising:
receiving a message from a first cell, the message comprising a list of one or more cells, information associated with applicability of one or more artificial intelligence/machine learning (AI/ML) operations, and a bias to apply to measurements during cell reselection, wherein the bias is associated with prioritizing cells in which the WTRU is able to continue the one or more AI/ML operations;
performing measurements on a second cell of the one or more cells;
applying the bias to the performed measurements based on one or more of the second cell being indicated by the network, the information associated with applicability of the one or more AI/ML operations of the second cell being the same as information associated with applicability of the one or more AI/ML operations of the first cell, or one or more network-side conditions of the second cell matching applicability criteria associated with the one or more AI/ML operations; and
reselecting to the second cell based on the biased measurements.

12. The method of claim 11, wherein the message from the first cell is a radio resource control (RRC) release with suspend message.

13. The method of claim 11, wherein the bias comprises an offset that prioritizes or deprioritizes a respective cell.

14. The method of claim 11, further comprising sending an indication to the second cell that indicates that the WTRU is performing the one or more AI/ML operations in the first cell.

15. The method of claim 14, further comprising receiving an acknowledgment (ACK) message from the network, the ACK message indicating that the WTRU is able to continue performing the one or more AI/ML operations in the second cell.

16. The method of claim 14, further comprising receiving a negative acknowledgment (NACK) message from the network, the NACK message indicating that the WTRU must discontinue performing the one or more AI/ML operations in the second cell.

17. The method of claim 11, wherein the one or more AI/ML operations comprise one or more of data collection, model training, inference, or performance monitoring.

18. The method of claim 11, further comprising initiating a random access channel (RACH) procedure when the one or more AI/ML operations are not supported by the second cell.

19. The method of claim 11, wherein the second cell is selected based on the second cell supporting continuation of the one or more AI/ML operations.

20. The method of claim 11, further comprising:
prioritizing a first subset of the one or more cells based on the biased measurements; and
deprioritizing a second subset of the one or more cells based on the biased measurements.
